(19) United States
(12) Patent Application Publication
(10) Pub. No.: US 2021/0324809 A1
(43) Pub. Date: Oct. 21, 2021

(54) Method and Device for Controlling the Injecting of a Non-Combustible Fluid

(71) Applicant: Hitachi Automotive Systems, Ltd., Hitachinaka-shi, Ibaraki (JP)

(72) Inventors: Naoki YONEYA, Tokyo (JP); Masayuki SARUWATARI, Hitachinaka-shi (JP)

(21) Appl. No.: 17/256,877

(22) PCT Filed: Jul. 3, 2019
(86) PCT No.: PCT/JP2019/026427

§ 371 Date: Dec. 29, 2020

(30) Foreign Application Priority Data
Jul. 6, 2018 (DE) 10 2018 211 206.1

(51) Int. Cl. F02D 41/00; F02D 41/14; F02B 47/02; F02M 25/022; F02M 25/03

(52) U.S. Cl. CPC F02D 41/0025; F02D 41/1401; F02B 47/02; F02D 2041/1412; F02M 25/03; F02M 25/0224; F02M 25/0227

(57) ABSTRACT

The present subject matter provides a device and a method for injecting non-combustible fluid into an internal combustion. In order to reduce the non-combustible fluid consumption, the fluid to be injected is heated to a predefined temperature which improves the spray characteristics, reduces wall wetting and leads to a better vaporization of the fluid in the combustion chamber.

### TECHNICAL FIELD

The present document relates to a control device and a system to inject a noncombustible fluid into an internal combustion engine, as well as a corresponding method and a computer program product for carrying out the method by means of a computer. It is a particular technical advantage of the claimed subject-matter that the injected amount of non-combustible fluid can be reduced by reducing or even avoiding wall wetting of the intake ports and the cylinder walls which leads to lower maintenance needs, e.g. due to longer refill cycles of the non-combustible fluid, and a reduced risk of engine damage. Preferably, the non-combustible fluid is water.

### BACKGROUND ART

Water injection is an effective measure for the prevention of knocking in state of the art vehicle-internal combustion engines. In addition, the injection of water into the internal combustion engine can reduce the fuel consumption of the internal combustion engine. So far, in most cases the water injection is realized as a port water injection, which means that the water is injected into the intake ports of the internal combustion engine. This kind of water injection allows for easier application of the water injector and a simpler overall water injection system compared with injecting the water directly in the combustion chamber. However, port water injection has the technical problem that an amount of the injected water condenses on the walls of the intake ports and is therefore not available for vaporization in the combustion chamber.

### CITATION LIST

### Patent Literature

PTL 1: Patent Literature 1: JP 2014-517185 A

### SUMMARY OF INVENTION

### Technical Problem

Patent Literature 1 describes an internal combustion engine of a vehicle which includes a combination of liquid water injection, high compression ratio and lean air fuel mixture. The amount of water to be injected is controlled in relation to inlet pressure, inlet temperature, relative humidity and current engine operating parameters.

A downside of water injection methods and devices known so far is that the water tank has to be rather large and/or that the water has to be refilled in relatively short time cycles because a part of the injected amount of water condenses at the intake port walls and is therefore not available for vaporization in the combustion chamber. The condensed water additionally increases the risk of an engine damage since water droplets can remove the oil film from the cylinder walls.

### Solution to Problem

The above-described technical problem is solved by the subject-matter according to the independent claims. Further preferred developments are described by the dependent claims.

The herein described and claimed subject-matter especially avoids or at least reduces water condensation on the intake port walls, the so-called “wall wetting”, by heating the injected water. The inventors have found that the reduction/avoiding of wall wetting can be beneficially achieved by injecting the non-combustible fluid, preferably water, at an increased temperature, which has the effect that the Reynolds number is increased and therefore the spray characteristics of the water injection are improved. Therefore, the amount of non-combustible fluid to be injected can be reduced by setting an increased temperature of the non-combustible fluid.

According to an aspect, the claimed subject-matter comprises a control device (control unit) configured to control the injection of a non-combustible fluid into an internal combustion engine. The internal combustion engine may have at least one cylinder, and at least one non-combustible fluid injector (or briefly: “fluid injector” or “injector”) configured to inject a non-combustible fluid into the internal combustion engine (briefly: “combustion engine” or “engine”). The control device may be integrated into the combustion engine or, alternatively, it may be disposed at a position within a vehicle remote to the combustion engine, and the control unit and the engine may be connected via one or more signal lines.

Preferably the non-combustible fluid is not/not fully combusted (i.e. at least partially inert) during the combustion within a cylinder of an internal combustion engine. More preferably, the non-combustible fluid is a gas or liquid with a high latent heat, wherein the latent heat of the fluid is at least 1/10 of the evaporation enthalpy of water. Most preferably, the non-combustible fluid is water which will be described in more detail further below.

The control device may be configured to control the temperature of the noncombustible fluid (briefly: “fluid”) to a predefined (temperature) value, which may mean that the temperature is controlled to arrive at the predefined temperature value. The controlling of the temperature of the fluid to arrive at a predefined value may include heating or cooling. More preferably, controlling the fluid temperature to arrive at the predefined value includes heating the fluid to a predefined temperature value.

The control device may be configured to control/start the injection of the fluid into the combustion engine after the predefined value was reached; alternatively, and more preferably, the control device may be configured to control the injection of the fluid into the combustion engine before a final predefined value was reached and during the, e.g., heat up of the fluid so that the determining of an amount of fluid to be injected (described in detail below) will be carried out, preferably each time, before the injection is carried out.

Furthermore, as another alternative, it is possible that the control device varies the (intermediate) predefined value of the temperature before an injection (preferably, before each injection) until the final predefined value of the temperature is reached.

A heating (or cooling) of the fluid may be carried out stepwise or continuously, wherein “stepwise” shall be understood as heating up the non-combustible fluid by a predefined temperature increase value, e.g. 5° C., stay at that temperature for a predefined time, e.g. 15 s, and repeating that procedure until the final predefined temperature is reached.

As mentioned above, the control device may be configured to determine an amount of non-combustible fluid to be injected based on the fluid temperature. The temperature value which is used to determine the amount of non-combustible fluid to be injected is preferably the actual temperature of the fluid shortly before it is injected, in particular if the control device controls the injector to inject the fluid during the heating/cooling of the fluid. Instead or in addition of/to using the temperature of the fluid shortly before it is injected, which may mean that the temperature of the fluid was measured within the fluid injector or within a feed pipe thereof, the temperature of the fluid within a storage tank or the like may be used.

Alternatively, if the fluid is injected after the intermediate/final predefined temperature value was reached, the control device may use said intermediate/final predefined temperature value for determining the amount of fluid to be injected.

The term “determine” may preferably include the meanings of “calculate” as well as “estimate”. For example, the control device may receive a signal from a fluid temperature sensor, which may measure the fluid temperature, and may calculate the amount of fluid to be injected based on the measured temperature. When a measured value of the fluid temperature is provided the control device may perform a closed loop temperature control, for increasing the accuracy of the determined amount of fluid to be injected. Alternatively or in addition, the control device may estimate the fluid temperature and may calculate the amount of fluid to be injected based on the estimated fluid temperature which may result in a feed forward control.

The control device may be configured to control the non-combustible fluid injector to inject the determined amount of non-combustible fluid into the internal combustion engine. Preferably, the at least one non-combustible fluid injector is a water injector and preferably it is disposed so that the non-combustible fluid/water is injected into the intake port. It may be preferable to have at least one intake port per cylinder. Alternatively or in addition, the at least one non-combustible fluid injector can be arranged so that the non-combustible fluid is injectable into the cylinder (combustion chamber). In this case, it is preferable to provide at least one water injector per cylinder of the internal combustion engine. In other words, the injector may be configured/disposed to inject the non-combustible fluid into the intake port and/or into the combustion chamber of the internal combustion engine. Further, the control device may be configured to control the non-combustible fluid injector to inject the non-combustible fluid into the intake port and/or into the combustion chamber of the internal combustion engine.

The control device configured to control the injection of the non-combustible fluid into the internal combustion engine as described above allows reducing wall wetting of non-combustible fluid on the intake port walls or on the cylinder walls of the internal combustion engine. This allows, i.a., to save non-combustible fluid, such as water, which has to be carried within the vehicle and which has to be refilled repeatedly. In other words, it may either be beneficially possible to reduce the size of the tank for the non-combustible fluid and/or to expand the refill intervals. Furthermore, avoiding condensation of non-combustible fluid on the engine walls reduces the risk that noncombustible fluid, such as water, enters into the oil circuit of the engine which could cause an engine damage.

Further, the control device may be configured to determine the amount of noncombustible fluid to be injected such that the determined amount decreases when the fluid temperature increases. In other words, when the temperature of the noncombustible fluid, such as water, is increasing, e.g. from 25° C. to 45° C. during the heating thereof, a decreased amount of fluid to be injected may be determined at 45° C. compared to the amount to be injected at 25° C. Injecting the water at higher temperatures into the intake port has been found to be advantageous to reduce the wall wetting and therefore to increase the amount of fluid vaporizing in the combustion chamber. The higher fluid temperature reduces the kinematic viscosity of the fluid, such as water, and therefore leads to a higher Reynolds number thereof. The Reynolds number is defined by the ratio of inertial forces to viscous forces within a fluid and can be calculated based on the following equation (1):

$$\begin{matrix}[ Math . 1 ] & \\ Re = \frac{{u}_{f} \cdot d}{{v}_{f}} & ( 1 )\end{matrix}$$

u_{f} is the velocity of the fluid, d is the representative diameter and v_{f} is the kinematic viscosity of the fluid.

A higher Reynolds number of the fluid flow inside the injector improves the spray break-up and therefore leads to less fluid condensation at the intake port walls. Since less water is lost by wall wetting, more water is vaporized inside the combustion chamber and therefore the combustion temperature can be reduced more efficiently so that less fluid to be injected is necessary to prevent knocking. It was found by the inventors that, although the temperature with which the fluid enters into the cylinder is higher and which was believed to have an adverse effect on the engine behaviour and fluid consumption, the higher amount of water which vaporizes inside the cylinder overcompensates the higher enthalpy of the incoming fluid. In other words, the inventors have found that the amount of injected fluid can be reduced to achieve the desired effects of supressing knocking and reducing fuel consumption due to the improved vaporization by injecting the fluid at a higher temperature into the intake port. This allows, i.a., to save non-combustible fluid, such as water, and prevents engine damage because of oil dilution.

Preferably, the control device may be configured to control the non-combustible fluid injector to inject the non-combustible fluid into the internal combustion engine when the internal combustion engine operates in a transient operating mode. The term “transient operating mode” may preferably be construed to entail driving situations during which a change of the load and/or speed and/or valve timing and/or EGR valve opening angle and/or throttle valve opening angle and/or other air-quantity-control device of the internal combustion engine occur. In other words, the internal combustion engine may, e.g., operate in a transient operating mode at a time or during a period at which/during which the load and/or speed and/or any of the airquantity-control devices of the internal combustion engine changes/varies.

Further, the control device may be configured to detect and/or predict a start and a duration of the transient operating mode and may be configured to determine an amount of non-combustible fluid to be injected during the transient operation mode which is higher than the determined amount to be injected during steady state mode, if compared at the same temperature. Accordingly, the control device may detect and/or predict the start of the transient operating mode. The control device, additionally or alternatively, may detect and/or predict the duration of the transient operating mode.

When the start of the transient operating mode was determined and/or at the predicted start of the transient operating mode the control device may increase the amount of non-combustible fluid to be injected. Further, the control device may also decrease the fluid injection amount after detecting the end of the transient operating mode or after the expiry of the predicted/determined duration of the transient operating mode.

The above described increased amount of fluid injection (increased compared to the steady state mode and at the same temperature) into the combustion engine during a transient operating mode has been found to be advantageous in view of reducing combustion temperatures, especially when the combustion conditions change in such a way that the combustion temperature upsurges, e.g., occurring when the load of the engine is rapidly raised or when a hot internal residual gas amount is increased. Further, it was found that the fuel consumption is lowered by the injecting an increased amount of fluid during the transient operating mode. Therefore, transient knocking can be prevented, performance of the internal combustion engine can be maintained, and fuel consumption can be reduced by increasing the amount of injected fluid during transient operating mode compared to the amount of injected fluid at steady state conditions.

For detecting a transient operating mode, e. g., a position of a pedal (as a pedalvalue) of a vehicle in which the internal combustion engine is disposed and or a first derivative of the position of the pedal (value), e.g. the change of the position over time, may be used. The pedal may, e.g., be the acceleration pedal or the brake pedal. These pedal values provide information about the target operating point and how fast it should be achieved. For example, it may be defined that if the gradient of changing the pedal position is larger than a predefined threshold, a transient operating mode is active. Further, a change in the pedal-value may require a reaction of multiple actuators of the internal combustion engine. Since every actuator may have a response delay time, the target values of the actuators may be used to predict the conditions of the target operating point in the cylinder. Additionally, dependent on response characteristic(s) of the different actuators, the start and the duration of the transient operating mode may be determined. For example, the target value of the intake valve closing and/or multiple values out of the intake valve switching sequence may be used to predict the expected air mass and the expected temperature. For this purpose, the control schemes which represent the behaviour of the applied actuators may be stored in the control device. The detection/prediction of the transient operating mode is not restricted to the above described methods but can also be performed in a different way, such as using data which is provided by external area sensors, e.g. a stereo camera, or the like.

By detecting/predicting the transient operating mode, which may be carried out by the control device, the water injection can be timed precisely and the above described benefits of the water injection during the transient operating mode are put into practice optimally.

Further, the control device may be configured to control the pressure at which the non-combustible fluid is injected to maintain a predefined value. The pressure at which the non-combustible fluid is injected may be controlled by measuring/estimating the pressure of the fluid in the fluid circuit close to the fluid injector or inside the fluid injector. When a measured value of the fluid pressure is provided a closed loop pressure control can be performed by the control device whereas an estimated fluid pressure may result in a feed forward control. To further increase the spray break-up, an increased fluid pressure has been found to be beneficial. Firstly, an increased fluid pressure leads to an increased Reynolds number by increasing the injection velocity. Furthermore, the Weber number We can be increased as well and to a greater extend, since the Weber number We depends on the square of the injection velocity. It is defined by the ratio of the inertial forces to the surface forces within a fluid droplet and can be calculated based on the following equation (2):

$$\begin{matrix}[ Math . 2 ] & \\ We = \frac{{ρ}_{f} \cdot {d}_{s} \cdot {u}_{f , dr}^{2}}{{σ}_{f}} & ( 2 )\end{matrix}$$

ρ_{f} is the density of the fluid, dₛ is the spray hole diameter of the fluid injector, u_{f,dr} is the velocity of the fluid droplets and σ_{f} is the surface tension of the fluid. Since the surface tension of the fluid is dependent on the temperature, too, the Weber number We also increases with increasing temperature but a pressure increase has a greater impact thereon.

A higher Weber number characterizes a more effective primary spray break-up with small droplets, which helps to avoid wall wetting. In other words, controlling the injection pressure as described above leads to an increased fluid velocity and therefore to an even more improved spray characteristic which avoids wall wetting and saves fluid consumption. This results in improved maintenance and lowers the risk of an engine damage caused by oil dilution.

Further, the non-combustible fluid may be water, and the (final) predefined temperature value of the water may be at least 15° C. Preferably the water temperature may be in a range of 25° C. to 99° C., more preferably the water temperature may be in a range of 35° C. to 99° C. and even more preferably the water temperature may be in a range of 40° C. to 99° C. Alternatively, the final predefined temperature value may also be set so that the same or at least approximately the same Reynolds number and Weber number are achieved when injecting the non-combustible fluid as if gasoline would be injected. In case of water, this temperature is about 47° C. If the latter temperature value is set, the heating of the water does consume less energy, however, the amount of water which can be saved is a bit lower.

Further, the predefined pressure value may be at least 1 bar higher than the pressure of the atmosphere into which the water is injected. Preferably the overpressure may be in a range of 2 bar to 30 bar and more preferably the water overpressure may be in a range of 7 bar to 15 bar, which, e.g., can be achieved by a common injection pump usually applied for port fuel injection or the like.

Performing fluid injection, preferably the fluid being water, in the above described temperature and pressure ranges results in reduced wall wetting and therefore reduces the general fluid/water consumption. Additionally, common and established components for pressure supply and injection can be used which helps to limit the costs of the water injection system.

Further, the claimed subject-matter may include a system which may comprise a control device which may be configured to control the injection of a non-combustible fluid into an internal combustion engine as described above. The control device or the control unit may be included in the internal combustion engine, wherein “include” may mean that the control unit is physically integrated with the engine or that it is remotely arranged, however, connected thereto by signal lines and the like.

Additionally, the system may comprise an internal combustion engine, wherein the internal combustion engine may have at least one cylinder, and at least one noncombustible fluid injector which may be configured to inject a non-combustible fluid into the internal combustion engine. Preferably, the internal combustion engine may have a variable valve train, a turbocharger and/or an internal EGR system. The engine may be a gasoline engine with a high compression ratio, e.g. 14 to 18.

The system may also comprise a heating device which may be configured to provide heat for heating the non-combustible fluid. The heating device may be an electrical heater which may be arranged at/in a fluid tank and/or at the fluid injector or at any other position suitable to heat up the amount of fluid to be injected. Additionally or alternatively, the heating device may include a heat exchanger which may be thermally connected to the coolant or the exhaust gas of the engine or to any other medium which is suitable to transfer heat.

Further, the system may comprise at least one heating device, wherein at least one of the heating devices is an electrical heater. The electrical heater may be disposed at the injector or at/in the tank. For disposing the electrical heater at the injector, a heating resistor or a heating coil or the like may be used, which may be applied around a fluid storage chamber inside the fluid injector. For heating up the fluid in a tank an immersion heater may be also conceivable. The application of an electrical heater provides secure heat supply and needs additional electrical energy. The final heating up to the predefined temperature value may be carried out in the injector. The amount of fluid to be heated inside the fluid injector is rather small and therefore causes negligible energy losses.

To further avoid energy losses caused by electrical heating of the non-combustible fluid, the system may comprise at least one conversion unit which may be configured to convert thermal energy into electrical energy for operating at least one of the electrical heaters. The conversion unit may be a thermoelectric generator (TEG), such as a Seebeck generator, which e.g. may be disposed around an exhaust gas pipe of the combustion engine. A TEG uses the Seebeck effect, which states that an electric voltage will arise in a conductor if it is subjected to a temperature difference. To avoid operating the TEG at unduly high temperatures, which could destroy the conducting material, the exhaust gas pipe may be implemented as a bypass.

Alternatively or in addition, an exhaust gas turbine may be implemented in the exhaust gas system of the engine which may drive an electric generator for supplying electrical energy to the electrical heater. The exhaust gas turbine may be disposed e.g. in a separate exhaust gas path and/or in the main exhaust gas path behind the turbine of the turbo charger. The electric generator may be the electric generator of the engine or a separate electric generator implemented only for providing energy for the electrical heater. Generating electrical energy in the above described manner prevents consumption of additional energy for fluid heating since the heating losses of the combustion engine are converted into electrical energy.

Further, the system may comprise at least one heating device, wherein at least one of the heating devices may be a heat exchanger comprising at least one flow path for the non-combustible fluid, and at least one flow path for the exhaust gas and/or the coolant of the internal combustion engine. The flow paths can be arranged in parallel-flow, counter current or cross-flow design. Preferably, the flow paths may be arranged in counter current design since this arrangement provides the highest efficiency. The heat exchanger may be designed as plate heat exchanger, plate-fin heat exchanger or shell and tube heat exchanger or any further design suitable for the use in vehicles. The heat exchanger may be disposed at a tank for storing the non-combustible fluid or along the non-combustible fluid pipe, preferably close to the fluid injector. More than one tank and more than one heat exchanger may be installed and several types of heat exchangers may be used. Operating heat exchangers in the above described manner leads to an efficient use of energy since the heating losses of the combustion engine are used for heating up the non-combustible fluid.

Further, the system may comprise at least one heating device, wherein at least one of the heating devices is disposed at the non-combustible fluid injector. The heating device may be an electrical heater as described above or the injector may be disposed in a heat transferring medium such as the engine coolant or the like. A combination of both can be implemented as well. In that case positioning the injector in a heat transferring medium leads to a pre-heating thereof wherein the electrical heater can be used for transient operating mode which requires a rapid heating of the noncombustible fluid. Heating the non-combustible fluid directly in the fluid injector has the advantage that only the amount of fluid to be injected must be heated up. Therefore, very little heating energy is necessary so that the overall fuel consumption is almost not affected.

Instead of or in addition, the system may also include one or more cooling devices, such as a heat exchanger or a Peltier element for enabling a possibly desired cooling of the fluid.

Further, the system may comprise at least one tank for storing the non-combustible fluid, wherein at least one of the heating devices may be disposed at at least one tank. The system may comprise more than one tank, which can be equipped with a heat exchanger. The tanks may be of different size, for example, one bigger main tank and a second smaller tank in which the water is heated up by a heat exchanger. Preferably, the second tank is disposed close to the non-combustible fluid injector to avoid heating losses on the way from the tank to the fluid injector. A combination of a heat exchanger at a fluid tank and an electrical heater at the fluid injector can be implemented as well. This combination provides preheating of the non-combustible fluid in the tank and reduces the electrical energy necessary for a fast heating up in transient driving situations.

Further, the claimed subject matter may include a method for controlling injection of a non-combustible fluid into an internal combustion engine, the internal combustion engine may have at least one cylinder, and at least one non-combustible fluid injector which may be configured to inject a non-combustible fluid into the internal combustion engine, wherein the method may comprise controlling the temperature of the noncombustible fluid to arrive at a predefined temperature value, determining an amount of non-combustible fluid to be injected based on the temperature of the noncombustible fluid, and controlling the non-combustible fluid injector to inject the determined amount of non-combustible fluid into the internal combustion engine. The method may also include further steps which can be derived from the configuration of the control device as described above.

Further, the claimed subject matter may include a computer program product storable in a memory comprising instructions which, when carried out by a computer, cause the computer to perform the method described above. “Include” may mean that the control unit is physically integrated with the engine or that it is remotely arranged, however, connected thereto by signal lines and the like.

### Advantageous Effects of Invention

Summarizing, the claimed subject-matter allows reducing the amount of fluid being used in a fluid-injection internal combustion engine in transient as well as in steady state driving situations. The reduced fluid amount is achieved by heating the fluid to a predefined temperature which improves the spray characteristics and therefore avoids wall wetting. The fluid is preferably water.

In the following the claimed subject-matter will be further explained based on at least one preferential example with reference to the attached exemplary drawings.

### BRIEF DESCRIPTION OF DRAWINGS

FIG. 1 depicts a schematic view of a cylinder of an internal combustion engine with water injection into the intake port;

FIG. 2 (FIGS. 2a-2c) illustrates the different fluid properties of water and gasoline or heptane;

FIG. 3 depicts a flow chart of the claimed control method;

FIG. 4 (FIGS. 4a-4b) depicts two signal-time-diagrams with a schematic trend of engine load, water amount and injected water temperature;

FIG. 5 (FIGS. 5a-5b) illustrates two examples for arranging the components of a water injection system;

FIG. 6 (FIGS. 6a-6b) shows two schematic examples of a heat exchanger;

FIG. 7 (FIGS. 7a-7c) illustrates three examples for arranging the water pump and the heating devices.

### DESCRIPTION OF EMBODIMENTS

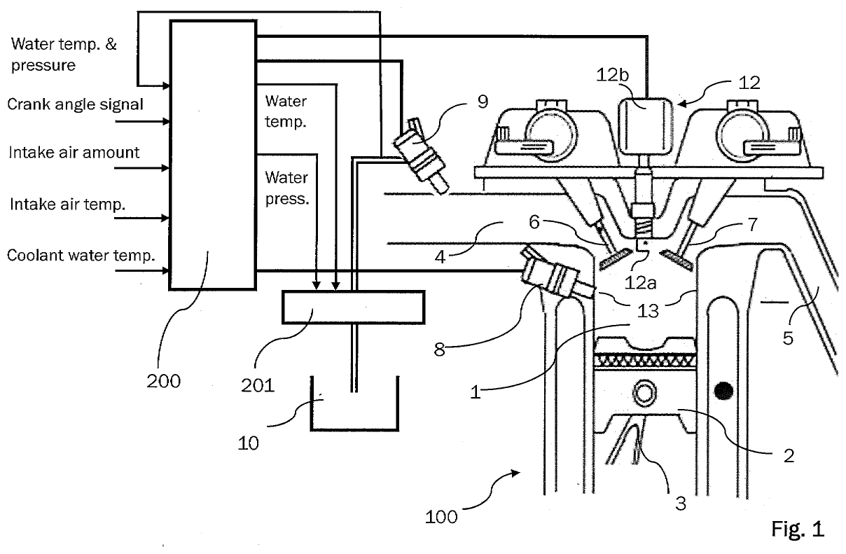

FIG. 1 depicts an exemplary cylinder 100 of an otherwise unspecified internal combustion engine, which may have more than one cylinder 100. The engine may, for example, have two, three, four, six, eight or less/more cylinders 100. The cylinder 100 comprises a combustion chamber 1 in which a piston 2 with a connecting rod 3 is disposed allowing it to travel. The connecting rod 3 is connected to a crankshaft (not depicted) that can be a crankshaft as known.

An (air) intake port 4 with an intake valve 6 as well as an exhaust port 5 with an exhaust valve 7 are connected to the combustion chamber 1. Ambient air is drawn into the combustion chamber 1 through the intake port 4. Exhaust gases are discharged from the combustion chamber 1 via the exhaust port 5. A spark ignition unit 12 comprising a spark plug 12a and an ignition coil 12b is attached to the internal combustion engine. The spark ignition unit 12 preferably offers a variable spark duration or multi-spark ignition. The internal combustion engine (or briefly: “combustion engine” or “engine”) may have one or more spark ignition units 12. Preferably, it has at least one spark ignition unit(s) 12 per cylinder 100. The spark plug 12a as well as a fuel injector 8, or at least parts thereof, are connected to the inside of the combustion chamber 1 so that a spark and fuel can be introduced/injected into the combustion chamber 1. The high-pressure fuel supply of the fuel injector 8 is not depicted. The fuel injector 8 may preferably be a direct fuel injector 8. Further, the fuel injector 8 may preferably be an electrohydraulic fuel injector or a piezoelectric fuel injector.

Further, a non-combustible fuel injector 9 is connected to the intake port 4 of the cylinder 100. Since most preferably the liquid to be injected is water, even though other liquids having a high evaporation enthalpy may be used as well, the term “water injector” is used as one specific example for a non-combustible fuel injector 9. The water injector 9 may be a low-pressure injector with an injection pressure of up to 15 bar or a high-pressure injector with an injection pressure of more than 15 bar. As an alternative to the water injector 9 connected to the intake port 4 (as shown in FIG. 1), or in addition thereto, one or more water injectors 9 may be connected to the cylinder wall 14 of one cylinder 100 to inject water directly into the combustion chamber 1.

A control unit 200 for controlling the water injection into the internal combustion engine is further shown in FIG. 1. The control unit 200 has a plurality of subunits which are placed at different positions of the vehicle.

One of these subunits is the water pressure and temperature control unit 201 which is configured to adjust and to control the pressure and the temperature of the water to be injected. For this purpose, the water pressure and temperature control unit 201 receives the target values for the water temperature and pressure from the control unit 200 by signal lines and controls the heating unit (not depicted) to provide the demanded water temperature and the pressure unit (not depicted) to provide the demanded pressure. The control unit 200 receives the actual pressure and temperature of the water to be injected from pressure and temperature sensors (not depicted) disposed in the water pipe close to the injector 9 or disposed inside the injector 9 or disposed at any other place of the water system suitable for detecting the relevant water pressure and temperature. Therefore, a feed-back control of the water pressure and temperature can be realized.

The control unit 200 may determine the amount of water to be injected by the injector 9 in accordance with predefined internal combustion engine states. E.g., the control unit 200 may use a map, a table or the like to determine the amount of water to be injected depending on the engine state, which may be defined by parameters and which are used to look up the amount of water to be injected. Subsequently, the control unit 200 may adapt the water amount based on the general state of the engine in accordance to the measured or estimated temperature and/or the measured or estimated pressure of the water to be injected. This adaption of the water amount may also be provided in a map, a table or the like or may be calculated based on equations.

The control unit 200 is electrically connected to the spark ignition unit 12, the direct fuel injector 8 and the water injector 9 and controls the multiple units/injectors/actuators. The control unit 200 may, for example, be the engine control unit (ECU) and the water pressure and temperature control unit 201 may be a part of the ECU or a separate subunit.

It may also be possible to implement the feed-back control of the water pressure and the water temperature into the water pressure and temperature control unit 201. In that case, the pressure and temperature sensors may be connected thereto. Furthermore, the calculation of the water amount depending on the water pressure and the water temperature may also be implemented in the water pressure and temperature control unit 201.

The control unit 200 may also be any other control unit, and signal line connections between the control unit 200 and the controlled units may differ from the example of FIG. 1. For example, there may be a plurality of control units 200 which may control subgroups of the controlled units, e.g. one control unit 200-1 may control only fuel injectors 8, another control unit 200-2 may control only water injectors 9 and so on. Even further, if there is a plurality of control units 200, these control units 200 may be interconnected with each other hierarchically or in another way. Alternatively, there may be one single control unit 200 which includes all the control functions of the multiple actuators.

Further, pressure sensors which are not shown may be disposed in the combustion chamber wall 14 so that the pressure within the combustion chamber 1 can be measured. Measuring the pressure within the combustion chamber 1 can support a feedback control of the amount of water to be injected.

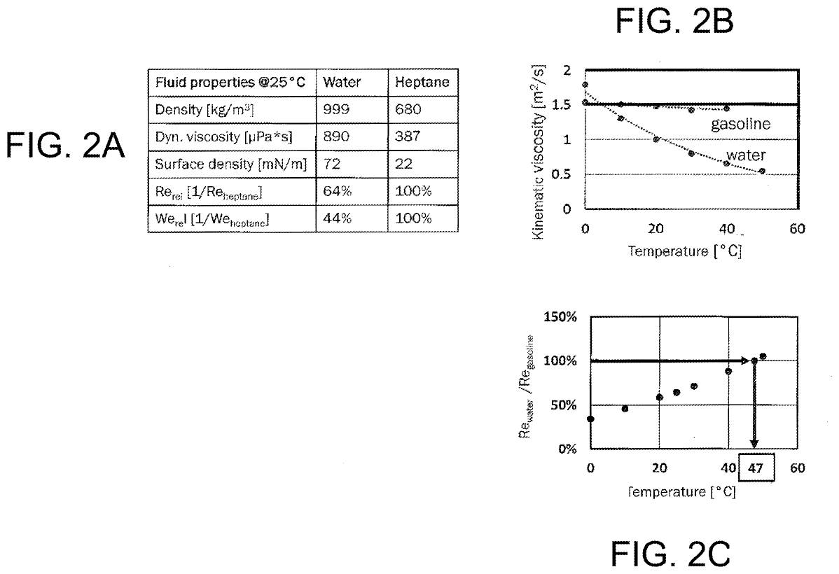

To further explain the effects leading to an improved atomization of the preheated injected water, the FIGS. 2a to 2c show a comparison of the fluid properties of water and gasoline or heptane which is used as a reference for gasoline. FIG. 2a shows a table which depicts the fluid properties of water and heptane at 25° C. It becomes clear that the density of water at 25° C. is significantly higher than the density of heptane. Therefore, the Reynolds number of water at that temperature is only 64% of the Reynolds number of gasoline. Furthermore, FIG. 2a shows that the surface density of water at 25° C. is higher than the surface density of heptane, which leads to a Weber number which is only 44% of the Weber number of heptane. Hence, the spray characteristics of water at 25° C. are worse compared to heptane, and therefore, using a port water injection, a higher amount of water condenses at the intake port walls compared to a port fuel injection of gasoline. The kinetic viscosity of water is however strongly dependent on its temperature which is not the case for gasoline, as FIG. 2b clearly depicts. Therefore, as the inventors found out, the Reynold number of water can be equalized to the Reynolds number of gasoline by heating up the water to 47° C., as shown in FIG. 2c. In other words, the spray characteristics of water can be adapted to the spray characteristics of gasoline by using water which has a temperature of approximately 47° C.

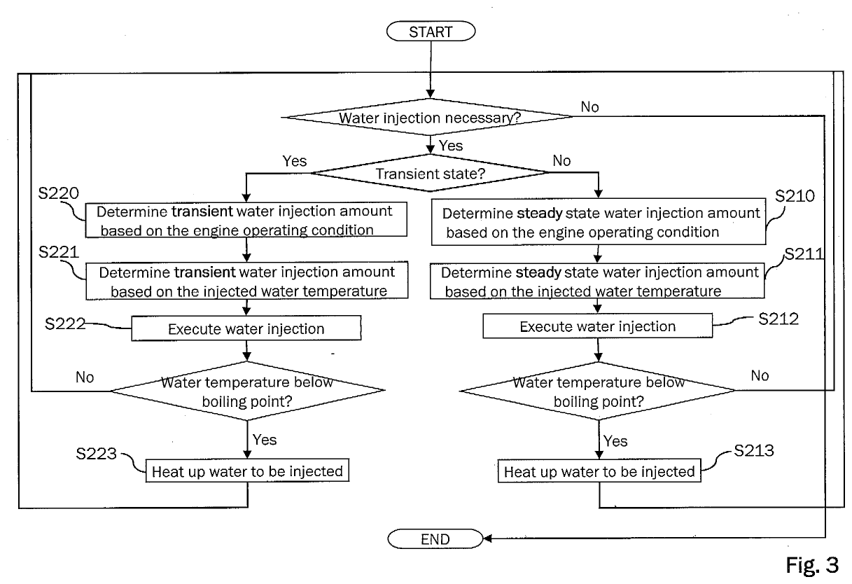

The flow chart of FIG. 3 depicts an example for a possible sequence of steps for controlling the amount of water to be injected at steady state and transient conditions. In this example the non-combustible fluid may be water and the predefined temperature of the water to be injected may be 100° C., but the controlling sequence is not limited to these conditions. Other liquids having a high evaporation enthalpy may be used as well and other predefined injection temperature values may also be used.

After checking whether water injection in general is necessary, which e.g. may be the case when the engine operates at a high load, it is determined whether the engine operates in transient or steady state mode. Depending on the determined engine operating mode, the steps S210 to S213 or S220 to S223 are performed. For transient operation the water amount based on the engine operating conditions is determined in step S220. In step S221 the previously determined water amount is adapted depending on the temperature of the water to be injected. Subsequently, water injection is executed in step S222. In the case that the water temperature is below the boiling point, which is chosen as predefined injection temperature in this example, the water is further heated up (S223). Other predefined temperature values than the boiling point may also be used.

Next the sequence starts again by checking the engine conditions (need of water injection in general and transient or steady state operating mode). When steady state operating mode is detected the water amount which is necessary for steady state operation is determined based on the engine operating conditions in step S210. Then the previously determined water amount is adapted depending on the temperature of the water to be injected (S211) and water injection is executed (S212). In the case that the water temperature is below the boiling point, the water is further heated up (S213). Then the sequence starts again and is repeated for steady state or transient operating mode until the engine reaches an operating point in which no water injection is required. In the above example, it should be understood that some steps may be left out and/or repeated. For example, several checking steps may be carried out subsequently or in parallel to determine the required water amount.

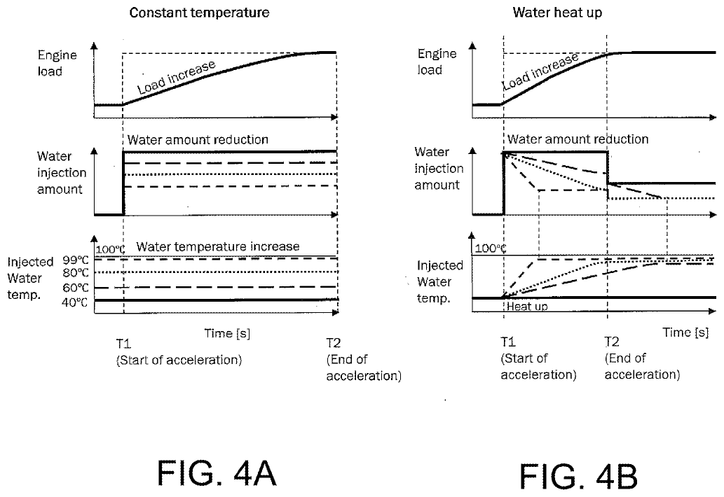

The FIGS. 4a and 4b illustrate the dependency of the injected amount of water on the temperature thereof. In this example water was again used as one example for a non-combustible fluid. In FIG. 4a a typical engine load increase/acceleration is depicted as an example starting at a first time T1 and ending at a second time T2. During each load increase water was injected at different temperatures (40° C., 60° C., 80° C. and 99° C.) and the water temperature was maintained constant during the acceleration. It is clearly recognizable that the required amount of water decreases with increasing water temperature and stays constant during the acceleration. In FIG. 4b the same example of an engine load increase/acceleration is depicted extended by a steady state operation at the load the engine reaches at the end of the acceleration. Different to the conditions in FIG. 4a, the water temperature was changed during the load increase from 40° C. to 99° C. in various ways. When the water temperature is maintained constant at 40° C. (solid line) the amount of water to be injected must be increased at the start of the acceleration and kept constant until the end of the acceleration. When the engine reaches a steady state operating point at a higher load compared to the operating point before the acceleration, the water amount can be reduced but stays higher than before the acceleration. When the water is heated up from 40° C. to 99° C. (broken lines) the previously increased water amount to be injected for transient operating mode can be decreased during the acceleration depending on the increasing water temperature. Furthermore, the required amount of water in steady state mode, injecting water having a temperature of 99° C., is lower compared to the required water amount at 40° C. water temperature.

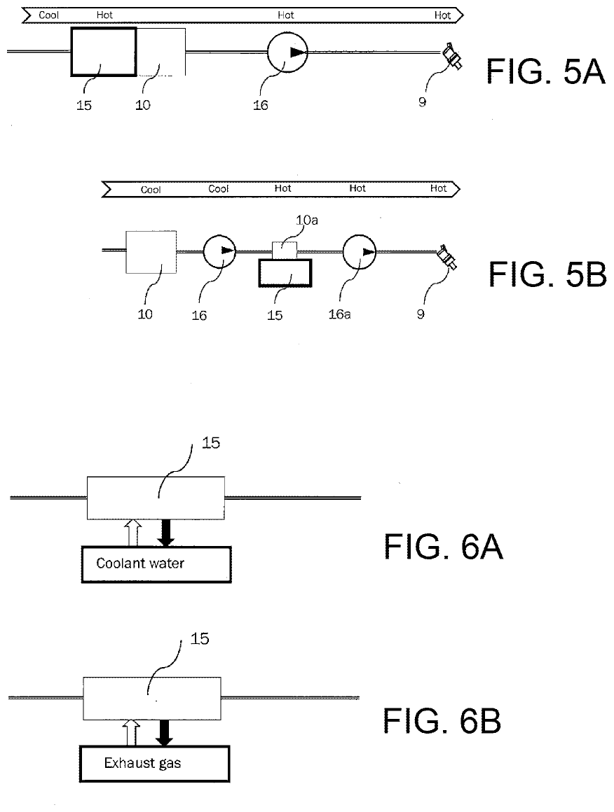

The FIGS. 5a and 5b depict two different examples of arranging heat exchangers 15, 15a and pumps 16, 16a to deliver the water, or another non-combustible fluid, from the tanks 10, 10a to the injector 9 at the demanded temperature and pressure. In this example water was again used as one example for a non-combustible fluid. In FIG. 5a the heat exchanger 15 is disposed at the water tank 10 and the water pump 16 is disposed between the tank 10 and the water injector 9. In that case, the water pump 16 has to compress preheated water. FIG. 5b shows an arrangement which includes two water pumps 16, 16a and two water tanks 10, 10a. The heat exchanger 15 is disposed at the smaller second water tank 10a, which is positioned between the two water pumps 16, 16a. The water from the water tank 10 is pre-compressed by the water pump 10 before it reaches the second tank 10a in which it is heated up by the heat exchanger 15. The second water pump 16a compresses the water to the predefined pressure value at which it is injected into by the water injector 9. The present application is not limited to the water system arrangements depicted in the FIGS. 5a and 5b. Further arrangements with more than two water tanks, more than one heat exchanger and more than two water pumps may be feasible. Furthermore, the positions of the heat exchangers, the water tanks and the water pumps may be changed. An especially preferred application scenario for the heat up as shown by FIGS. 5a and 5b may relate to hybrid electric vehicles in which the coolant water temperature may frequently decrease due to frequent engine stops. The above explained heat up of the water of FIGS. 5a and 5b can realize that the water to be injected at the water injector reliably has the correct, predefined temperature value achieved with an efficient heating control strategy.

The FIGS. 6a and 6b show two different ways to transfer heat by a heat exchanger 15 which may be used for heating or cooling the non-combustible fluid, which preferably is water. FIG. 6a shows the heat exchanger 15 thermally connected to the coolant of the engine and FIG. 6b shows the heat exchanger 15 thermally connected to the exhaust gas of the engine. The heat exchanger 15 may be designed as plate heat exchanger, plate-fin heat exchanger or shell and tube heat exchanger or any further design suitable for the use in vehicles. The heat exchanger 15 may be disposed at a tank 10, 10a for storing the non-combustible fluid or along the non-combustible fluid pipe, preferably close to the fluid injector.

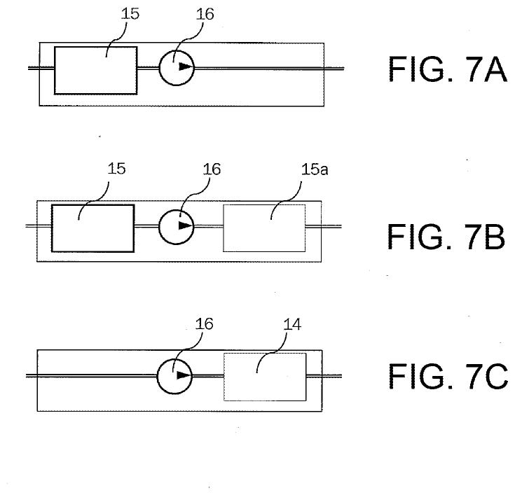

The FIGS. 7a to 7c illustrate three examples for disposing heating units in relation to the pump 16. The heating units may be used for heating (or cooling) the noncombustible fluid, which preferably is water. In FIG. 7a one water pump 16 is arranged behind a single heat exchanger 15. FIG. 7b depicts the arrangement of FIG. 7a extended by a second heat exchanger 15a, which preferably should exchange heat without pressure losses since it is arranged behind the water pump 16. FIG. 7c shows a single water heater 17 disposed behind the water pump which provides heat without producing pressure losses. The claimed subject matter is not limited to the examples depicted in the FIGS. 7a to 7c. The number and the layout of the heating units may vary and different positions of the water pumps and the heat exchangers may be possible as well.

It is summarized that the present subject-matter enables saving non-combustible fluid, such as water, by avoiding wall wetting when using an internal combustion engine having water injection to suppress knocking at high engine loads and during transient driving situations.

While the above describes a particular order of operations performed by certain aspects and examples, it should be understood that such order is exemplary, as alternatives may perform the operations in a different order, combine certain operations, overlap certain operations, or the like. References in the specification to a given aspect indicate that the aspect described may include a particular feature, structure, or characteristic, but every aspect may not necessarily include the particular feature, structure, or characteristic. The features which are described herein and which are shown by the Figures may be combined. The herein described and claimed subject-matter shall also entail these combinations as long as they fall under scope of the independent claims.

It should again be noted that the description and drawings merely illustrate the principles of the proposed methods, devices and systems. It will thus be appreciated that those skilled in the art will be able to devise various arrangements that, although not explicitly described or shown herein, embody the principles of the claimed subjectmatter and are included within its spirit and scope.

Furthermore, it should be noted that steps of various above-described methods and components of described systems can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

In addition, it should be noted that the functions of the various elements described herein may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “control unit” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

Finally, it should be noted that any block diagrams herein represent conceptual views of illustrative circuitry embodying the principles of the claimed subject-matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Again summarizing, the present subject-matter offers an effective concept to save water consumption (water as a preferred example of non-combustible fluid to be injected) in a water-injection internal combustion engine in transient as well as in steady state driving situations. The reduced water amount is achieved by heating the water to a predefined temperature which improves the spray characteristics and therefore avoids wall wetting. Heating the water directly in the water injector allows for an efficient use of energy since only a small amount of water has to be heated up.

### REFERENCE SIGNS LIST

1 combustion chamber
2 piston
3 connecting rod
4 intake port
5 exhaust port
6 intake valve
7 exhaust valve
8 fuel injector
9 non-combustible fluid/water injector
10, 10a (water) tank
11 spark ignition
12a spark plug
12b ignition coil
13 cylinder wall
14 (water) heater
15, 15a heat exchanger
16, 16a (water) pump
100 cylinder
200 control unit, control device
201 (water) pressure and temperature control unit

1. Control device (200) for controlling injection of a non-combustible fluid into an internal combustion engine, the internal combustion engine having at least one cylinder (100), and at least one noncombustible fluid injector (9) configured to inject a non-combustible fluid into the internal combustion engine,
wherein the control device (200) is configured
to control the temperature of the non-combustible fluid to arrive at a predefined temperature value,
to determine an amount of non-combustible fluid to be injected based on the temperature of the non-combustible fluid, and
to control the non-combustible fluid injector (9) to inject the determined amount of non-combustible fluid into the internal combustion engine.

2. Control device (200) according to claim 1, wherein the control device (200) is configured to heat the non-combustible fluid and to decrease the amount of non-combustible fluid to be injected with an increase of the temperature of the non-combustible fluid.

3. Control device (200) according to claim 1, wherein the control device (200) is configured to detect and/or to predict a start and a duration of the transient operating mode, and to control the non-combustible fluid injector (9) to inject the non-combustible fluid into the internal combustion engine when the internal combustion engine operates in a transient operating mode.

4. Control device (200) according to claim 1, wherein, at the same temperature of the non-combustible fluid, the control device (200) is configured to determine a higher amount of non-combustible fluid to be injected during a transient operation than during a steady state mode.

5. Control device (200) according to claim 1, wherein the control device (200) is configured to control the pressure at which the noncombustible fluid is injected to maintain a predefined pressure value.

6. Control device (200) according to claim 1, wherein the noncombustible fluid is water and the predefined temperature value of the water is at least 15° C.

7. Control device (200) according to claim 1, wherein the noncombustible fluid is water and the predefined pressure value is at least 1 bar higher than the pressure of the atmosphere into which the water is injected.

8. A system comprising:
the control device (200) according to claim 1,
an internal combustion engine, the internal combustion engine having at least one cylinder (100), and at least one non-combustible fluid injector (9) configured to inject a non-combustible fluid into the internal combustion engine, and
at least one heating device configured to provide heat for heating the non-combustible fluid to a predefined temperature value.

9. The system according to claim 8, wherein at least one of the heating devices is an electrical heater.

10. The system according to claim 8, further comprising at least one conversion unit, configured to convert thermal energy into electrical energy for providing electrical power to at least one of the electrical heaters.

11. The system according to claim 8, wherein at least one of the heating devices is a heat exchanger (15, 15a) comprising at least one flow path for the non-combustible fluid, and at least one flow path for the exhaust gas of the internal combustion engine.

12. The system according to claim 8, wherein at least one of the heating devices is a heat exchanger (15, 15a) comprising at least one flow path for the non-combustible fluid, and at least one flow path for coolant of the internal combustion engine.

13. The system according to claim 8, wherein at least one of the heating devices is disposed at the non-combustible fluid injector (9).

14. The system according to claim 8, further comprising at least one tank (10, 10a) for storing the non-combustible fluid, wherein at least one of the heating devices is disposed at at least one tank (10, 10a).

15. Method for controlling injection of a non-combustible fluid into an internal combustion engine, the internal combustion engine having at least one cylinder (100), and at least one non-combustible fluid injector (9) configured to inject a non-combustible fluid into the internal combustion engine, wherein
controlling the temperature of the non-combustible fluid to arrive at a predefined temperature value,
determining an amount of non-combustible fluid to be injected based on the temperature of the non-combustible fluid, and
controlling the non-combustible fluid injector (9) to inject the determined amount of non-combustible fluid into the internal combustion engine.

16. A computer program product storable in a memory comprising instructions which, when carried out by a computer, cause the computer to perform the method according to claim 15.
